(19) United States
(12) Patent Application Publication
(10) Pub. No.: US 2015/0012530 A1
(43) Pub. Date: Jan. 8, 2015

(54) DETERMINING AN EMERGENT IDENTITY OVER TIME

(71) Applicant: Accenture Global Services Limited, Dublin (IE)

(72) Inventors: James Whitehead, Davidsonville, MD (US); Mark Crego, Springfield, VA (US); Alastair R. Partington, Hertfordshire (GB)

(73) Assignee: Accenture Global Services Limited, Dublin (IE)

(21) Appl. No.: 14/013,697

(22) Filed: Aug. 29, 2013

Related U.S. Application Data
(60) Provisional application No. 61/843,188, filed on Jul. 5, 2013.

(51) Int. Cl. G06F 17/30

(52) U.S. Cl. CPC G06F 17/3053
USPC 707/732

(57) ABSTRACT

A device may receive identity information associated with an identity, and may determine a relationship between at least one of: the identity and another identity, or the identity and an attribute. The device may determine a credibility score, associated with the relationship, that indicates a likelihood that the relationship is an accurate representation of the identity. The device may determine a confidence score based on the identity information and the credibility score, and may output or store the confidence score.

### RELATED APPLICATION

This application claims priority under 35 U.S.C. §119 to U.S. Provisional Patent Application No. 61/843,188, filed on Jul. 5, 2013, the content of which is incorporated by reference herein in its entirety.

### BACKGROUND

A person's identity may be represented by a variety of attributes associated with the person, such as the person's name, address, date of birth, appearance, etc. The more attributes that are known about the person, the more accurate the representation of the person's identity will be. In some cases, the attributes associated with the person may change over time. For example, the person may change names, addresses, appearance, etc.

### SUMMARY

In some implementations, a device may receive identity information associated with a person, and may determine a relationship between at least one of: the person and another person, or the person and an attribute. The device may generate a credibility score, associated with the relationship, that indicates a likelihood that the relationship is an accurate representation of the person. The device may receive an identity query associated with the identity information, and may generate a confidence score based on the identity information, the credibility score, and the identity query. The device may provide, based on receiving the identity query, a result based on the confidence score.

In some implementations, a device may receive identity information associated with an identity, and may determine a relationship between at least one of: the identity and another identity, or the identity and an attribute. The device may determine a credibility score, associated with the relationship, that indicates a likelihood that the relationship is an accurate representation of the identity. The device may determine a confidence score based on the identity information and the credibility score, and may output or store the confidence score.

In some implementations, a device may receive identity information associated with a person, and may determine a relationship between at least one of: the person and another person, or the person and an attribute. The device may determine a credibility score associated with the relationship. The credibility score may indicate a likelihood that the relationship is an accurate representation of the person. The device may determine a confidence score based on the identity information and the credibility score, and may output or store the confidence score.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for determining and storing relationships between items of identity information;

FIGS. 5A-5D are diagrams of an example implementation relating to the example process shown in FIG. 4;

FIG. 6 is a flow chart of an example process for analyzing identity information to generate and provide a result based on an identity query;

FIG. 7 is a diagram of an example implementation relating to the example process shown in FIG. 6; and

FIGS. 8A and 8B are diagrams of another example implementation relating to the example process shown in FIG. 6.

### DETAILED DESCRIPTION

The following detailed description of example implementations refers to the accompanying drawings. The same reference numbers in different drawings may identify the same or similar elements.

A person's identity may be represented by a variety of attributes associated with the person, such as the person's name, address, date of birth, appearance, etc. As additional attributes of the person are discovered over time, a representation of the person's identity may change. For example, the representation of the person's identity may become more accurate as additional attributes of the person are discovered. However, in some instances, an incorrect attribute may be associated with the person, resulting in an inaccurate representation of the person's identity. Implementations described herein may provide a more accurate representation of a person's identity by taking into account changes in the person's attributes over time, as well as by determining probabilistic relationships between the person, other people, and/or attributes of the person.

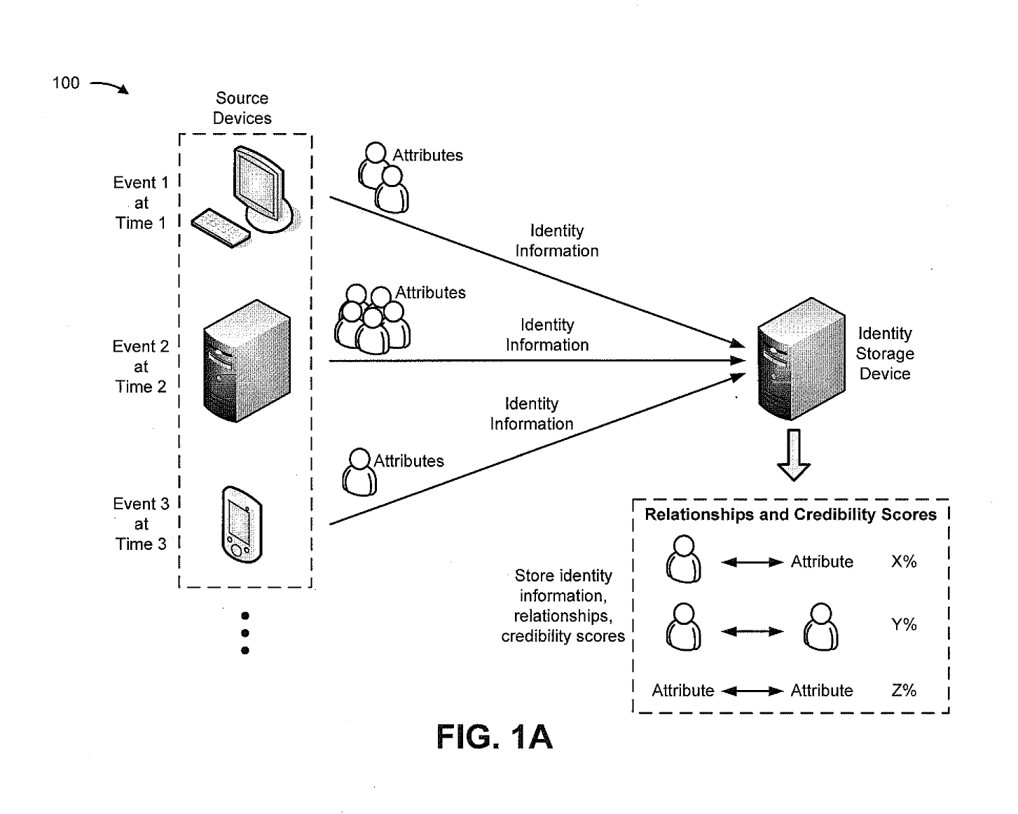

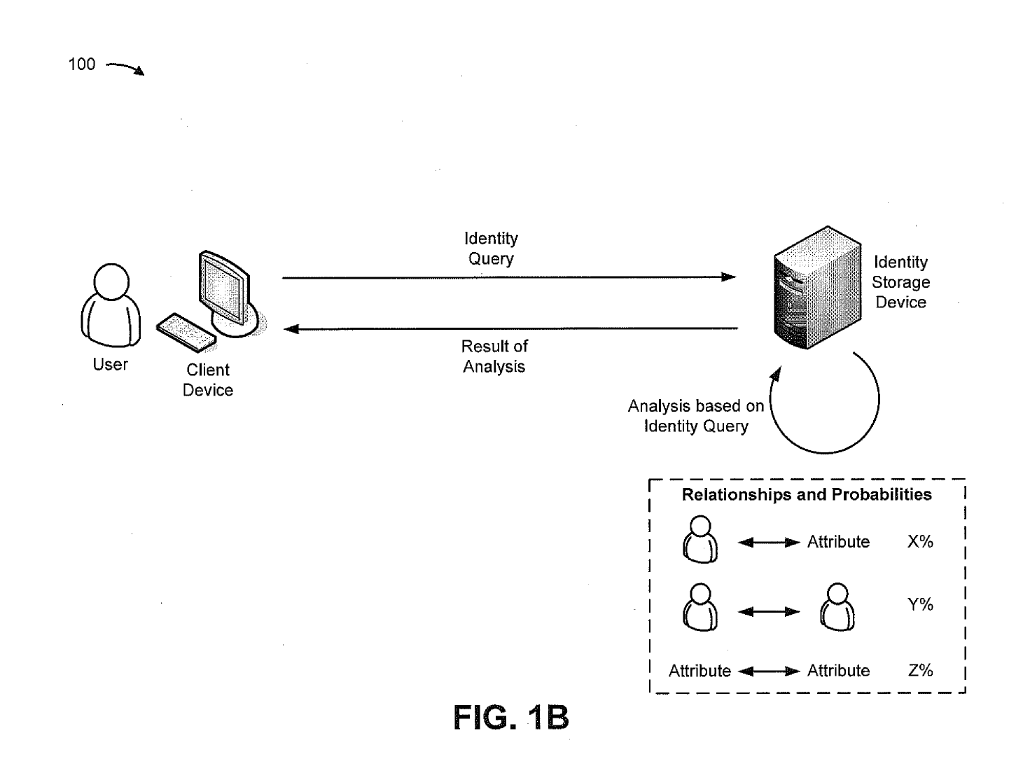

FIGS. 1A and 1B are diagrams of an overview of an example implementation 100 described herein. As shown in FIG. 1A, implementation 100 may include multiple source devices, such as a computer, a server, and a mobile phone, that transmit identity information to an identity storage device, such as a server. The identity information may be associated with different events that occur at different times, and the identity information may include information that identifies a person and/or an attribute of the person. For example, an event may include a person entering a country via an airplane flight, and the attributes may include a name of the person, a passport number of the person, a name of the country entered, a date that the person entered the country, and a flight number of the airplane flight. The identity storage device may receive identity information for multiple events, people, and/or attributes.

As further shown in FIG. 1A, the identity storage device may determine a relationship between different items included in the identity information (e.g., between a person and an attribute, between a person and another person, between an attribute and an attribute), and may determine a credibility score for the relationship. The credibility score may indicate a likelihood that the relationship is an accurate representation of the relationship between the items of identity information. For example, the credibility score may indicate a probability that a person was born on a particular day, a probability that a person knows another person, a probability that a particular credit card number has a particular expiration date, etc. The identity storage device may store the identity information, the relationships, and/or the credibility scores, as shown.

As shown in FIG. 1B, a user may interact with a client device, such as a computer, to cause the client device to transmit an identity query to the identity storage device. For example, the user may request to verify a person's identity. The identity storage device may receive the identity query, and may analyze the stored identity information, relationships, and/or credibility scores based on the identity query. For example, the identity storage device may compare identity information, included in the identity query, to stored identity information, relationships, and/or credibility scores to verify the person's identity. As further shown, the identity storage device may transmit, to the client device, a result of the analysis. For example, the identity storage device may provide an indication of a probability that the person is who the person is claiming to be (e.g., to verify the person's identity).

By processing and analyzing identity information in this manner, the identity storage device is able to provide the user with a more accurate result of the user's identity query. The identity storage device receives additional identity information over time, thus improving the accuracy of the stored identity information, the relationships between items of identity information, and the credibility scores associated with the identity information and/or the relationships. Additionally, the identity storage device determines a credibility score for different items of identity information and/or a credibility score for a relationship between different items of identity information, thus improving the identity query result by providing the user with a confidence score indicative of the accuracy of the information.

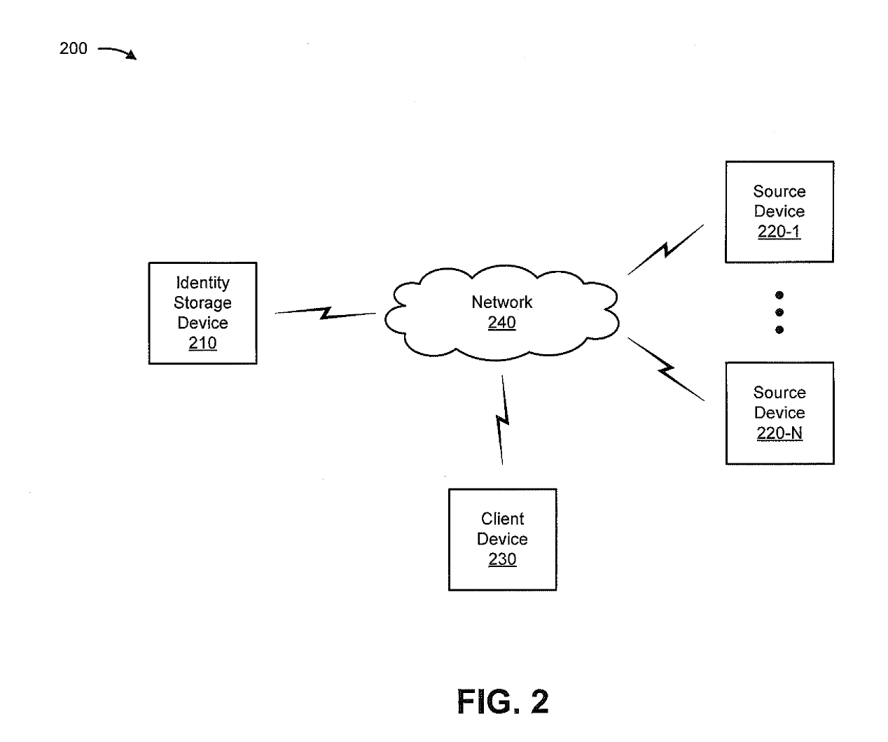

FIG. 2 is a diagram of an example environment 200 in which systems and/or methods described herein may be implemented. As shown in FIG. 2, environment 200 may include an identity storage device 210, one or more source devices 220-1 through 220-N (N≧1) (hereinafter referred to collectively as “source devices 220,” and individually as “source device 220”), a client device 230, and a network 240. Devices of environment 200 may interconnect via wired connections, wireless connections, or a combination of wired and wireless connections.

Identity storage device 210 may include one or more devices capable of receiving, generating, storing, processing, and/or providing identity information (e.g., information identifying a person and/or an attribute of a person) and/or information generated from identity information. For example, identity storage device 210 may include a computing device, such as a server, a desktop computer, a laptop computer, a tablet computer, a handheld computer, or a similar device. In some implementations, identity storage device 210 may receive identity information from source devices 220, and may process the identity information (e.g., to determine relationships between items of identity information and/or to generate a credibility score associated with items of identity information). Additionally, or alternatively, identity storage device 210 may receive an identity query from client device 230, and may provide the identity information and/or the processed identity information to client device 230 based on the identity query.

Source device 220 may include one or more devices capable of receiving, generating, storing, processing, and/or providing identity information. For example, identity storage device 210 may include a computing device, such as a server, a desktop computer, a laptop computer, a tablet computer, a handheld computer, a mobile phone, or a similar device. In some implementations, source device 220 may receive identity information input by a user and/or received from another device, and may provide the identity information to identity storage device 210.

Client device 230 may include one or more devices capable of receiving, generating, storing, processing, and/or providing identity information and/or information generated from identity information. For example, client device 230 may include a computing device, such as a desktop computer, a laptop computer, a tablet computer, a handheld computer, a mobile phone, or a similar device. In some implementations, client device 230 may receive an identity query (e.g., input by a user), may transmit the identity query to identity storage device 210, and may receive a response to the identity query (e.g., a result of an analysis of identity information) from identity storage device 210.

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, or a combination of these or other types of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

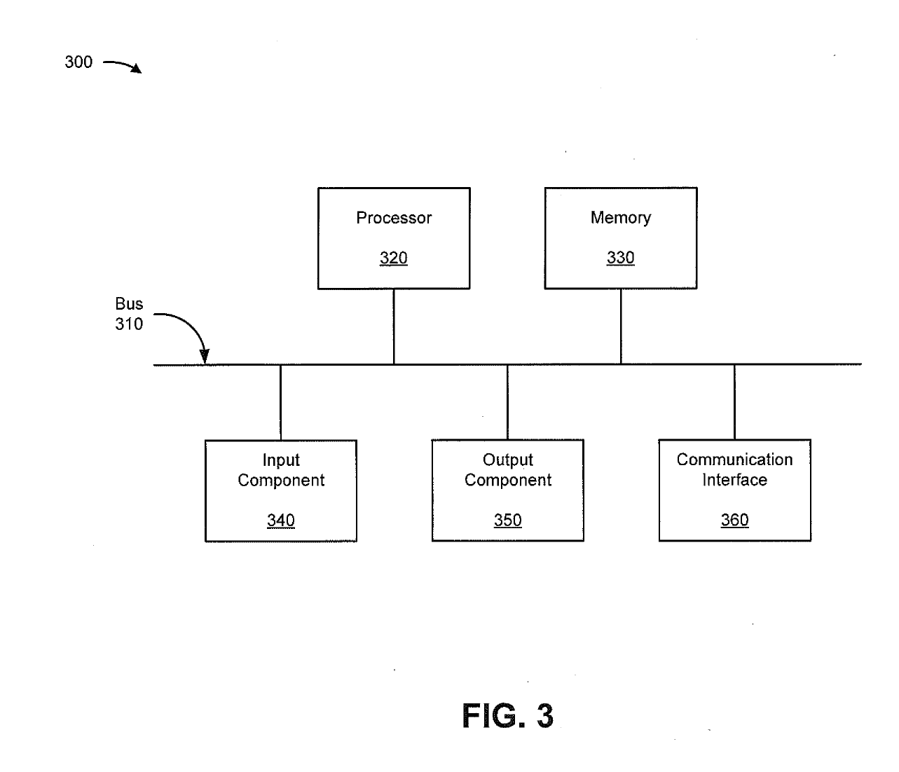

FIG. 3 is a diagram of example components of a device 300. Device 300 may correspond to identity storage device 210, source device 220, and/or client device 230. Additionally, or alternatively, each of identity storage device 210, source device 220, and/or client device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3.

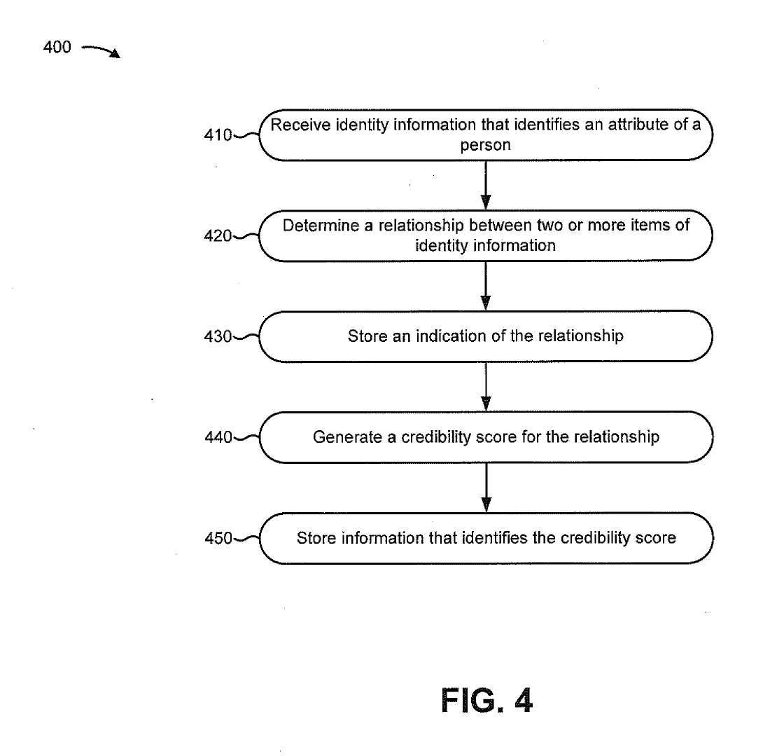

FIG. 4 is a flow chart of an example process 400 for determining and storing relationships between items of identity information. In some implementations, one or more process blocks of FIG. 4 may be performed by identity storage device 210. In some implementations, one or more process blocks of FIG. 4 may be performed by another device or a group of devices separate from or including identity storage device 210, such as source device 220 and/or client device 230.

As shown in FIG. 4, process 400 may include receiving identity information that identifies an attribute of a person (block 410). For example, identity storage device 210 may receive identity information from source device 220. The identity information may include information that identifies an attribute of a person. An attribute, as used herein, is to be broadly construed as any information that may be associated with a person.

For example, an attribute may include a biological characteristic of a person (e.g., a biometric, a physical characteristic, etc.). Examples of biological characteristics include a height, a weight, a handedness (e.g., right-handed or left-handed), a fingerprint, a skin color, a gait, a DNA characteristic, a blood type, an eye color, a hair color, a voice characteristic, or the like.

As another example, the attribute may include a biographical characteristic of a person. Examples of biographical characteristics include a name, a date of birth, a citizenship, an address (e.g., a home address, a work address), a unique identifier (e.g., a social security number, a passport number, etc.), a job title, an employer name, an action taken by a person and/or a behavior exhibited by the person (e.g., attending an event, purchasing an item, traveling on a flight, etc.), or the like.

Additionally, or alternatively, the attribute may identity an item that a person has (e.g., a badge, an identification card, a token, a document, etc.), information that a person knows (e.g., a personal identification number, a password, historical and/or biographical information, etc.), and/or a characteristic of the person (e.g., a biological characteristic and/or a behavioral characteristic).

In some implementations, identity storage device 210 may associate the attribute with a time element. For example, a biological characteristic of a person may change over time (e.g., a person may gain height, lose weight, dye their hair, etc.), a biographical characteristic of the person may change over time (e.g., a person may move to a new address, may change their name, etc.), or the like. Identity storage device 210 may associate the attribute with a particular time and/or a period of time (e.g., identified by a start time and/or an end time) that the attribute was observed and/or recorded. In this way, identity storage device 210 may store a representation of a person's identity that changes over time.

Identity storage device 210 may receive, from source device 220, identity information associated with an event. An event may occur at a particular time (and/or over a particular time period), and may be associated with one or more items of identity information, such as one or more attributes of a person. For example, an event may include a person entering a country via an airplane flight and checking into customs, and identity information associated with the event may include a name of the person, a passport number of the person, a citizenship of the person, a flight number of the airplane flight, a departure location of the flight (e.g., a country, a city, a gate number, etc.), an arrival location of the flight, a date and time associated with the event (e.g., a date and time that the flight arrived, that a customs agent gathered the identity information, etc.), a fingerprint sample taken by a customs agent, or the like.

In some implementations, identity storage device 210 may determine the identity information based on event information received from source device 220. For example, identity storage device 210 may parse the event information to identify an attribute (e.g., Mike Smith), and may extract the attribute from the event information. In some implementations, identity storage device 210 may label the attribute (e.g., Name=Mike Smith).

In some implementations, identity storage device 210 may receive user input that specifies identity information associated with a person. Additionally, or alternatively, a user may indicate that particular identity information is associated with a temporary scenario. For example, a user may input identity information for a temporary scenario, and identity storage device 210 may store the identity information along with an indication that the identity information is associated with a temporary scenario. In some implementations, the user may provide input indicating that identity storage device 210 is to delete identity information associated with the temporary scenario, and identity storage device 210 may remove the identity information from storage based on receiving the indication.

As further shown in FIG. 4, process 400 may include determining a relationship between two or more items of identity information (block 420). For example, identity storage device 210 may determine a relationship between two or more items of identity information received from one or more source devices 220. An item of identity information, as used herein, may refer to an attribute or a person. A person may be identified by an attribute and/or a collection of attributes. In some implementations, a person may be represented by an identity identifier (e.g., an identity number of 1), which may be associated with one or more attributes (e.g., a name of the person, a date of birth of the person, etc.).

In some implementations, identity storage device 210 may determine a relationship between a person and an attribute. For example, identity storage device 210 may determine that a particular person (e.g., identified by an identity identifier) is associated with a name, such as Mike Smith. In some implementations, identity storage device 210 may determine a relationship between a single person and a single attribute, a single person and a collection of attributes, a collection of people and a single attribute, and/or a collection of people and a collection of attributes.

Additionally, or alternatively, identity storage device 210 may determine a relationship between two people. For example, identity storage device 210 may determine that a first person (e.g., identified by an identity identifier of 1) is associated with (e.g., knows, is related to, is married to, etc.) a second person (e.g., identified by identity identifier of 2). In some implementations, identity storage device 210 may determine a relationship between a single person and another single person, a single person and a collection of people, and/or a first collection of people and a second collection of people.

Additionally, or alternatively, identity storage device 210 may determine a relationship between two attributes. For example, identity storage device 210 may determine that a first attribute (e.g., a credit card number) is associated with a second attribute (e.g., an expiration date). In some implementations, identity storage device 210 may determine a relationship between a single attribute and another single attribute, a single attribute and a collection of attributes, and/or a first collection of attributes and a second collection of attributes. Additionally, or alternatively, identity storage device 210 may associate an attribute with a sub-attribute. For example, a person may be associated with an attribute of having a credit card. A sub-attribute of the credit card may include a type of credit card (e.g., Visa, MasterCard, etc.). A sub-attribute of the type of credit card may include a credit card number, and so forth.

In some implementations, identity storage device 210 may determine a relationship between two attributes based on an attribute dictionary (e.g., specified by a user) that identifies attributes that are related (e.g., that are synonyms, that are an attribute and a sub-attribute, that are related based on a fuzzy matching algorithm, etc.). Identity storage device 210 may update the attribute dictionary (e.g., stored in a data structure) as attributes are determined from event information. In some implementations, identity storage device 210 may use a single attribute label (e.g., date of birth) to store identity information for attributes that are determined to be related (e.g., attributes labeled as birthday, birth date, DOB, etc.).

Identity storage device 210 may associate the relationship with a time element, in some implementations. For example, a relationship between people may change over time (e.g., two people who were married may get divorced), a relationship between attributes may change over time (e.g., a credit card number may be renewed and receive a new expiration date), a relationship between a person and an attribute may change over time (e.g., a person may move to a new address, may change their name, etc.), or the like. Identity storage device 210 may associate the relationship with a particular time and/or a period of time that the relationship was observed and/or determined. In this way, identity storage device 210 may store a representation of a person's identity that changes over time.

In some implementations, identity storage device 210 may determine a relationship between items of identity information associated with a single event and/or received together from source device 220 (e.g., in a single transaction, within a threshold time period, etc.). Additionally, or alternatively, identity storage device 210 may determine a relationship between items of identity information associated with multiple events and/or received separately from one or more source devices 220 (e.g., in multiple transactions, not within a threshold time period, etc.).

For example, identity storage device 210 may receive first identity information associated with a first event, and may store the first identity information. At a later time, identity storage device 210 may receive second identity information associated with an event (e.g., the first event or a different event), and may determine a relationship between items of the first identity information and items of the second identity information. Identity storage device 210 may determine the relationship using an index (e.g., by indexing information regarding people, attributes, and/or relationships), a search algorithm (e.g., a fuzzy search algorithm), a matching algorithm (e.g., a fuzzy matching algorithm), or the like. Alternatively, identity storage device 210 may determine that there is no relationship between items of the first identity information and items of the second identity information (e.g., using an index, a search algorithm, a matching algorithm, etc.).

In some implementations, identity storage device 210 may receive identity information from multiple source devices 220. Identity storage device 210 may process the received identity information (e.g., may determine relationships) based on a priority level associated with the source devices 220 from which the identity information is received. For example, a first source device 220 (e.g., an official government computer) may be associated with a higher priority than a second source device 220 (e.g., a retailer computer). Identity storage device 210 may process identity information received from the first source device 220 before processing the identity information received from the second source device 220. In some implementations, a priority level of source device 220 may be based on a credibility score associated with source device 220 (e.g., a source device 220 associated with a high credibility score may be associated with a higher priority level than a source device 220 associated with a low credibility score). Credibility scores are discussed in more detail elsewhere herein.

Identity storage device 210 may update the stored identity information (e.g., the stored attributes, identity identifiers that represent people, relationships, etc.) as additional identity information is received. In this way, a relationship determined by identity storage device 210 may become a more accurate representation of a person over time.

In some implementations, identity storage device 210 may receive user input that specifies a relationship between two or more items of identity information. Additionally, or alternatively, a user may indicate that a particular relationship is associated with a temporary scenario. For example, a user may input a relationship for a temporary scenario, and identity storage device 210 may store an indication of the relationship along with an indication that the relationship is associated with a temporary scenario. In some implementations, the user may provide input indicating that identity storage device 210 is to delete the relationship associated with the temporary scenario, and identity storage device 210 may remove the indication of the relationship from storage based on receiving the indication.

As further shown in FIG. 4, process 400 may include storing an indication of the relationship (block 430). For example, identity storage device 210 may store an indication of the relationship in a data structure. The stored indication may identity two or more items of identity information and a relationship between the two or more items. For example, a person may “have” an attribute, a first person may “know” a second person, a first attribute may “be associated with” a second attribute, or the like.

In some implementations, identity storage device 210 may determine that received identity information is to be associated with a new identity (e.g., a person identified by an identity identifier, such as an identity number). For example, identity storage device 210 may determine that received identity information does not have a relationship with stored (e.g., existing) identity information, or that identity storage device 210 does not have sufficient information to determine whether the received identity information has a relationship with stored identity information. In this instance, identity storage device 210 may create a new identity, and may store an association between the new identity and the received identity information. Additionally, or alternatively, identity storage device 210 may prompt a user to provide input indicating whether a new identity is to be created by identity storage device 210.

Alternatively, identity storage device 210 may determine that received identity information is to be associated with a stored identity (e.g., a person identified by a stored identity number). For example, the received identity information may include one or more attributes and/or a threshold quantity of attributes that match and/or are similar to (e.g., share a relationship with) stored attributes. In this instance, identity storage device 210 may store an association between the stored identity and the received identity information. Additionally, or alternatively, identity storage device 210 may prompt a user to provide input indicating whether an association between the stored identity and the received identity information is to be stored by identity storage device 210. In some implementations, identity storage device 210 may determine that the received identity information has a relationship with multiple stored identities. In this instance, identity storage device 210 may provide an indication of the multiple stored identities (e.g., to a user via a user interface), and may receive user input indicating an identity, of the multiple stored identities, with which the received identity information is to be associated.

In some implementations, identity storage device 210 may determine that stored identity information is to be associated with other stored identity information (e.g., that a first identity and a second identity are to be merged). For example, identity storage device 210 may store a first identity for a person named “Wanda Smith” and may store a second identity for a person named “Wanda Jackson.” At a later time, identity storage device 210 may receive new information indicating that Wanda Smith got married and changed her name to Wanda Jackson. Based on this new information, identity storage device 210 may merge the identities for Wanda Smith and Wanda Jackson by storing an association between the stored identity information for Wanda Smith and the stored identity information for Wanda Jackson. Additionally, or alternatively, identity storage device 210 may prompt a user to provide input indicating whether two or more identities are to be merged by identity storage device 210.

In some implementations, identity storage device 210 may determine that stored identity information is incorrectly associated with other stored identity information (e.g., that an identity is to be split into a first identity and a second identity). For example, identity storage device 210 may store an identity for a person named “David Brown” who has lived in Connecticut and Virginia. At a later time, identity storage device 210 may receive new information identifying two current driver's license numbers for a person named David Brown, where the first driver's license number is associated with Connecticut and the second driver's license number is associated with Virginia. Based on this new information, identity storage device 210 may split the identity of David Brown into two identities, one for a David Brown who lives in Connecticut, and one for a David Brown who lives in Virginia. Additionally, or alternatively, identity storage device 210 may prompt a user to provide input indicating whether an identity is to be split into two or more identities by identity storage device 210.

As further shown in FIG. 4, process 400 may include generating a credibility score for the relationship (block 440). For example, identity storage device 210 may generate a credibility score for a relationship between two or more items of identity information. In some implementations, the credibility score may indicate a likelihood that the relationship is accurate. Additionally, or alternatively, the credibility score may indicate a likelihood of a particular relationship between an attribute and another attribute, a person and another person, or an attribute and a person. For example, the relationship may identify an association between an attribute and a person (e.g., a person represented by an identity number). In this instance, the credibility score may indicate a likelihood that the attribute is an accurate representation of the person.

In some implementations, identity storage device 210 may generate the credibility score based on a source of the identity information associated with the relationship. A source may refer to a source device 220 from which identity information is received, a type of person that input the identity information, (e.g., an official, a civilian, a federal agent, etc.), a particular person that input the identity information (e.g., a badge number of an official), or the like. For example, identity storage device 210 may generate a higher credibility score for a relationship when a federal agent inputs the identity information associated with the relationship than when a civilian inputs the identity information associated with the relationship.

Additionally, or alternatively, identity storage device 210 may generate the credibility score based on a type of identity information. For example, identity storage device 210 may generate a higher credibility score for a relationship that associates a fingerprint or a DNA characteristic with a person than for a relationship that associates a favorite sports team with the person.

Additionally, or alternatively, identity storage device 210 may generate the credibility score based on a value of the identity information. For example, identity storage device 210 may receive identity information indicating that a person is five years old and has a driver's license. Identity storage device 210 may generate a low credibility score for a relationship between the person and one or both of these items of identity information (e.g., age and possession of driver's license), since it is unlikely that a five-year-old has a driver's license.

Identity storage device 210 may generate the credibility score based on a quantity of occurrences of a value of identity information, in some implementations. For example, identity storage device 210 may receive ten indications that a person's birthday is January 8, and may receive one indication that the person's birthday in January 9. Based on receiving a greater quantity of indications that the person's birthday is January 8, identity storage device 210 may generate a higher credibility score for a relationship between the person and a birthday of January 8, and a lower credibility score for a relationship between the person and a birthday of January 9.

In some implementations, identity storage device 210 may generate the credibility score based on event information regarding an event with which the identity information is associated. For example, event information may identify a location associated with the event (e.g., a physical location, a virtual address, such as an internet protocol (IP) address, etc.), an entity associated with an event (e.g., a company from which a purchase is made), or the like. For example, identity information may indicate that a person arrived via an airplane flight in San Francisco at 9 a.m. Eastern time, and arrived via an airplane flight in New York at 10 a.m. Eastern time. Identity storage device 210 may generate a low credibility score for a relationship between the person and identity information obtained based on one or both of these events (e.g., arriving in San Francisco and arriving in New York), since it is unlikely that the person was able to fly across the United States of America in one hour.

Identity storage device 210 may generate the credibility score based on one or more scoring rules. A scoring rule may be input by a user and/or may be generated based on stored (e.g., received) identity information and/or stored (e.g., determined) relationships between items of identity information. For example, identity storage device 210 may determine that a percentage of people, under the age of 16 and with a driver's license, is less than a threshold quantity. Based on this determination, identity storage device 210 may generate a lower credibility score for a relationship between a person under the age of 16 having a driver's license, and may generate a higher credibility score for a relationship between a person over the age of 16 having a driver's license.

In some implementations, identity storage device 210 may generate the credibility score based on input, received from a user, indicating a preference for a factor used to generate the credibility score, such as a particular source, a particular type of identity information, a particular value and/or set of values for the identity information (e.g., for a particular type of identity information), a particular quantity of occurrences of a value of identity information (e.g., a threshold quantity of occurrences), particular event information, particular scoring rules, or the like. For example, identity storage device 210 may weigh factors in a different manner based on the indicated user preference. In some implementations, a credibility score associated with a particular factor may override other credibility scores associated with other factors.

Additionally, or alternatively, identity storage device 210 may generate the credibility score based on adjudication information. The adjudication information may identify an adjudicatory decision made by a user, and may identify a credibility score associated with the adjudicatory decision. For example, a user may indicate that a particular attribute and/or relationship is not credible, and identity storage device 210 may generate a low credibility score (e.g., zero) for the attribute and/or the relationship. Alternatively, the user may indicate that a particular attribute and/or relationship is credible, and identity storage device 210 may generate a high credibility score (e.g., one, 100%, etc.) for the attribute and/or the relationship. In some implementations, identity storage device 210 may override the adjudicatory decision based on additional identity information associated with the attribute, the relationship, or a person associated with the attribute and/or the relationship (e.g., additional information that conflicts with the adjudicatory decision).

Identity storage device 210 may update the credibility score as additional identity information and/or user input is received. For example, a particular source may become more or less credible over time. In this way, a credibility score determined by identity storage device 210 may indicate a more accurate representation of credibility over time.

In some implementations, identity storage device 210 may receive user input that specifies a credibility score for a relationship. Additionally, or alternatively, a user may indicate that a particular credibility score is associated with a temporary scenario. For example, a user may input a credibility score for a temporary scenario, and identity storage device 210 may store information that identifies the credibility score along with an indication that the credibility score is associated with a temporary scenario. In some implementations, the user may provide input indicating that identity storage device 210 is to delete the credibility score associated with the temporary scenario, and identity storage device 210 may remove the information associated with the credibility score from storage based on receiving the indication.

As further shown in FIG. 4, process 400 may include storing information that identifies the credibility score (block 450). For example, identity storage device 210 may store information that identifies the credibility score in a data structure. Furthermore, identity storage device 210 may store an association between the credibility score and a relationship and/or item of identity information with which the credibility score is associated. In some implementations, identity storage device 210 may store, for example, a first item of identity information, a second item of identity information, a relationship between the first item and the second item, and/or the credibility score associated with the relationship. As an example, identity storage device 210 may store the first item of identity information, the second item of identity information, the relationship, and the credibility score as a quad (e.g., subject—relationship—object—credibility score). In some implementations, identity storage device 210 may store information in a relational database.

While a series of blocks has been described with regard to FIG. 4, the blocks and/or the order of the blocks may be modified in some implementations. Additionally, or alternatively, non-dependent blocks may be performed in parallel. Furthermore, one or more blocks may be omitted in some implementations.

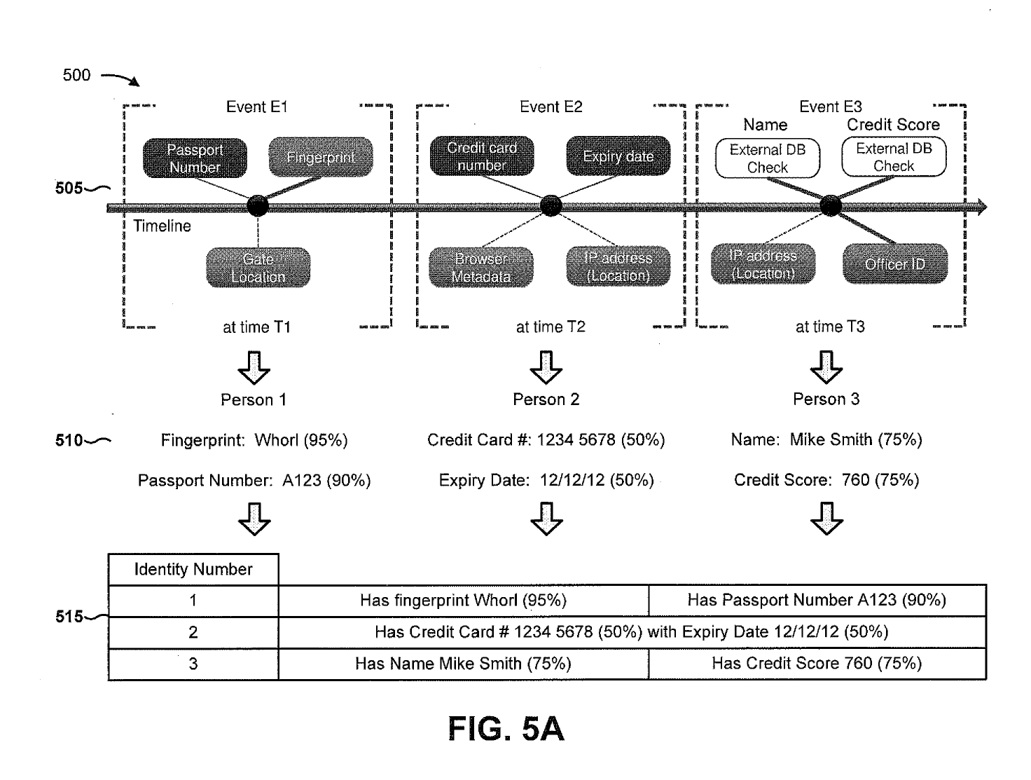

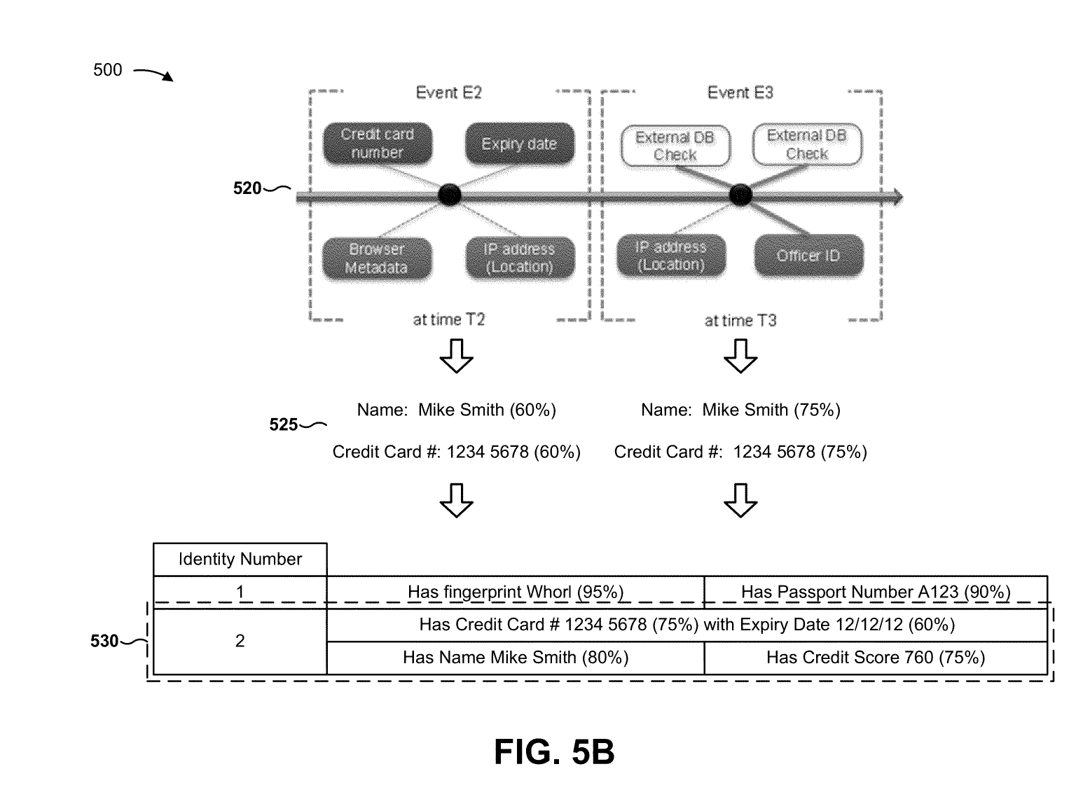

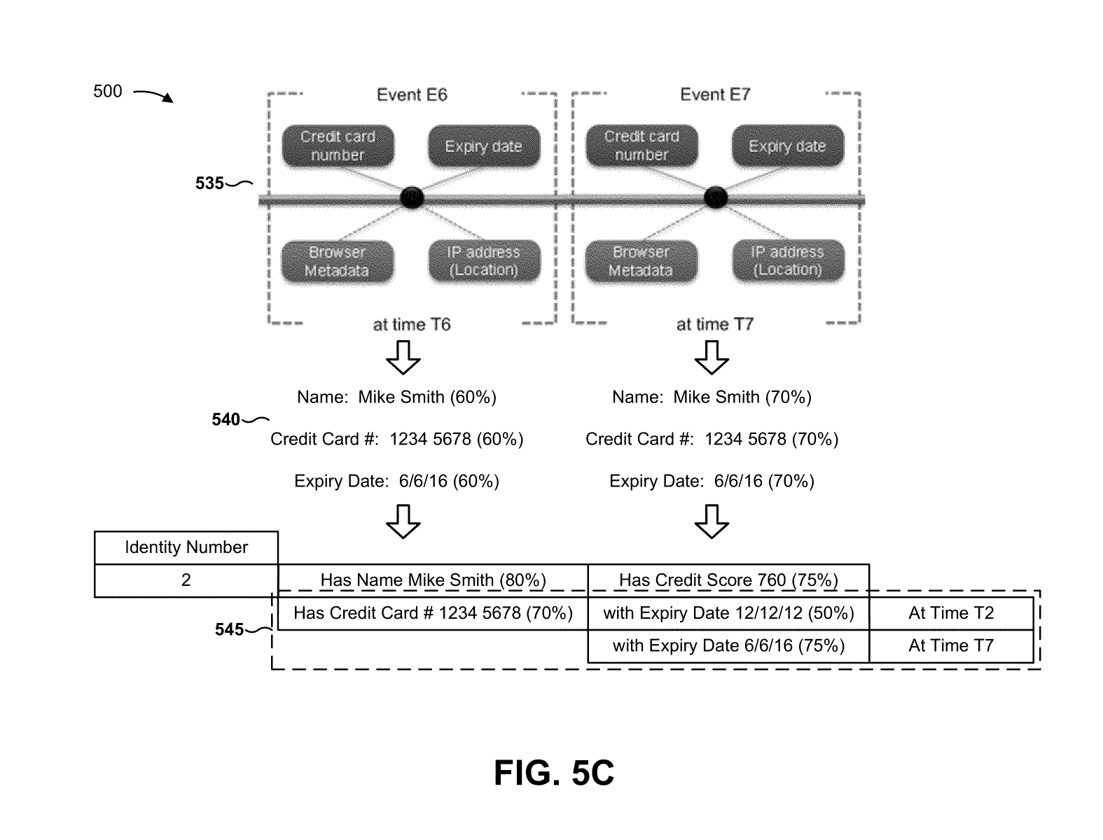

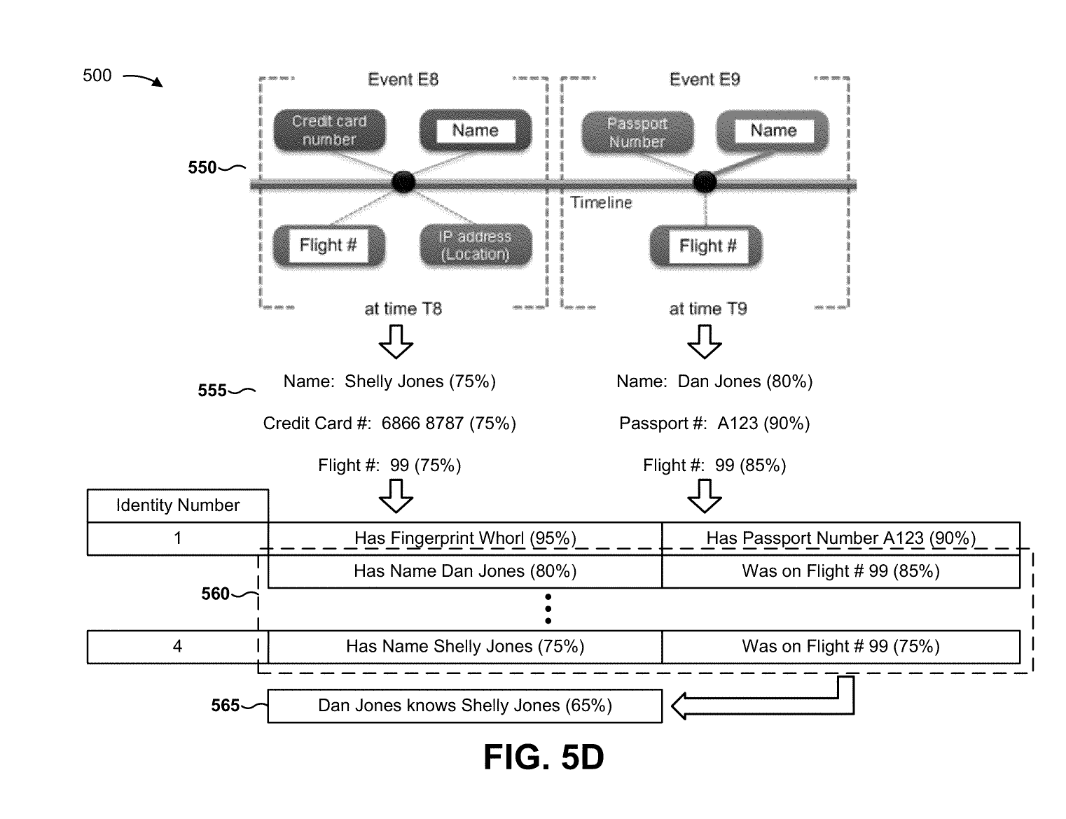

FIGS. 5A-5D are diagrams of an example implementation 500 relating to example process 400 shown in FIG. 4. FIG. 5A show an example where identity storage device 210 receives event information, determines items of identity information and relationships between items of identity information based on the event information, generates a credibility score for the relationships, and stores an association between identity information, a relationship, and a credibility score.

As shown in FIG. 5A, and by reference number 505, assume that identity storage device 210 receives event information associated with event E1 at time T1, receives event information associated with event E2 at time T2, and receives event information associated with event E3 at time T3.

Assume that event E1 represents a person entering a country on an airplane flight and checking in with a customs official. Event information from event E1 may identify a passport number of a person, a fingerprint of a person, and a gate location at which the flight arrived. Identity storage device 210 may extract identity information, from the event information, for a first person identified as “Person 1” (e.g., a first identity).

As shown by reference number 510, identity storage device 210 may determine relationships between attributes and the first person, and may generate a credibility score for the relationships. For example, assume that identity storage device 210 determines that Person 1 has a particular whorl fingerprint with a probability of 95%, and that Person 1 has a passport number of A123 with a probability of 90%. These relatively high credibility scores may be based on, for example, a source of the identity information (e.g., a customs official), a type of the identity information (e.g., a fingerprint being more credible than a passport number), or the like.

As shown by reference number 515, identity storage device 210 may store an indication of the identity information, the relationship, and the credibility score. For example, stored information corresponding to Identity Number 1 indicates that Person 1 has a whorl fingerprint with 95% probability and has a passport number of A123 with 90% probability. The stored information is provided as an example. As an alternative example, identity storage device 210 may store a credibility score that indicates a likelihood that Person 1 arrived at a particular gate (e.g., a gate location), a credibility score that indicates a likelihood that a person with a particular whorl fingerprint has a passport number of A123, or other information.

As further shown in FIG. 5A, assume that event E2 represents a person purchasing clothing, from an online retailer, using a credit card. Event information from event E2 may identify a credit card number used for the purchase, an expiration date of the credit card, browser metadata identified based on the purchase (e.g., a type of item purchased, such as men's clothing), and a location where the purchase was made (e.g., based on an IP address of a computer used to make the purchase). Identity storage device 210 may extract identity information, from the event information, for a second person identified as “Person 2.”

As shown by reference number 510, assume that identity storage device 210 determines that Person 2 has a credit card number of 1234 5678 with a probability of 50%, and that Person 2 has a credit card with an expiration date of Dec. 12, 2012 with a probability of 50%. These relatively low credibility scores may be based on, for example, a source of the identity information (e.g., an online retailer having lower credibility than the customs official of event E1), a type of the identity information (e.g., a credit card may be stolen more easily than a passport or a fingerprint), or the like.

As shown by reference number 515, assume that stored information corresponding to Identity Number 2 indicates that Person 2 has a credit card number of 1234 5678 with 50% probability and has a credit card with an expiration date of Dec. 12, 2012 with 50% probability. The stored information is provided as an example. As an alternative example, identity storage device 210 may store a credibility score that indicates a likelihood that Person 2 is a male (e.g., based on a purchase of men's clothing), a credibility score that indicates a likelihood that Person 2 is located at a particular location (e.g., based on an IP address used to make the purchase), a credibility score that indicates a likelihood that a credit card with a number of 1234 5678 has an expiration date of Dec. 12, 2012, or the like.

As further shown in FIG. 5A, assume that event E3 represents information gathered from an external database that identifies a person's name and credit score. Event information from event E3 may identify the name, the credit score, an identity of a credit bureau official responsible for gathering the credit score information, and a location of the credit bureau. Identity storage device 210 may extract identity information, from the event information, for a third person identified as “Person 3.”

As shown by reference number 510, assume that identity storage device 210 determines that Person 3 is named Mike Smith with a probability of 75%, and that Person 3 has a credit score of 760 with a probability of 75%. These intermediate credibility scores may be based on, for example, a source of the identity information (e.g., a credit bureau having a higher credibility than the online retailer of event E2 and a lower credibility than the customs official of event E1), a type of the identity information (e.g., a common name like Mike Smith may be less credible to use for identification than a passport number), or the like.

As shown by reference number 515, assume that stored information corresponding to Identity Number 3 indicates that Person 3 is named Mike Smith with 75% probability and has a credit score of 760 with 75% probability. The stored information is provided as an example. As an alternative example, identity storage device 210 may store a credibility score that indicates a likelihood that Person 3 is a male (e.g., based on the person's name), or the like.

FIG. 5B shows an example where identity storage device 210 receives event information, determines a relationship between stored identity information based on the event information, and merges different identities based on determining the relationship.

As shown in FIG. 5B, and by reference number 520, assume that event E4 represents a purchase made by a person named Mike Smith using credit card number 1234 5678. Further assume that event E5 represents information obtained from a credit card company indicating that a person named Mike Smith owns credit card number 1234 5678. As shown by reference number 525, assume that identity storage device 210 extracts identity information and generates a credibility score for a relationship between items of the identity information, as described elsewhere herein.

Further assume that identity storage device 210 determines, based on the identity information extracted from events E4 and E5, that Person 2 and Person 3 (FIG. 5A) are the same person. Based on this determination, identity storage device 210 may merge the identities of Person 2 and Person 3 by associating identity information of Persons 2 and 3 with a single identity (e.g., Identity Number 2), as shown by reference number 530.

FIG. 5C shows an example where identity storage device 210 stores a relationship between two attributes. As shown by reference number 535, assume that event E6 represents a purchase made by a person named Mike Smith using credit card number 1234 5678 with an expiration date of Jun. 6, 2016. Further assume that event E7 represents another purchase made by a person named Mike Smith using credit card number 1234 5678 with an expiration date of Jun. 6, 2016. As shown by reference number 540, assume that identity storage device 210 extracts identity information and generates a credibility score for a relationship between items of the identity information, as described elsewhere herein.

Recall (from FIG. 5A) that identity storage device 210 has stored a credibility score indicating that credit card number 1234 5678 is associated with expiration date Dec. 12, 2012 with probability 50%. This credibility score is based on information gathered from event E2 at time T2. Based on information obtained from events E6 and E7, assume that identity storage device 210 stores a credibility score indicating that credit card number 1234 5678 is associated with expiration date Jun. 6, 2016 with probability 75%. As shown by reference number 545, identity storage device 210 may continue to store an indication of the relationship to expiration date Dec. 12, 2012, and may additionally store an indication of the relationship to expiration date Jun. 6, 2016. Identity storage device 210 may associate the stored relationship with a time element, as shown.

FIG. 5D shows an example where identity storage device 210 stores a relationship between two people. As shown by reference number 550, assume that event E8 represents a purchase of a ticket for airplane flight number 99, made by a person named Shelly Jones, using credit card number 6866 8787. Further assume that event E9 represents a person named Dan Jones, with a passport number of A123, entering a country on airplane flight number 99. As shown by reference number 555, assume that identity storage device 210 extracts identity information and generates a credibility score for a relationship between items of the identity information, as described elsewhere herein.

As shown by reference number 560, identity storage device 210 may determine that Person 1, who is associated with passport number A123, is named Dan Jones with probability 80%, and was on flight number 99 with probability 85%. Identity storage device 210 may store this relationship by associating the identity information with Identity Number 1, as shown. Additionally, assume that identity storage device 210 stores an identity for Person 4 (e.g., Identity Number 4), who is named Shelly Jones with probability 75%, and who was on flight number 99 with probability 75%.

As shown by reference number 565, identity storage device 210 may determine a relationship between Dan Jones and Shelly Jones, such as “Dan Jones knows Shelly Jones” (or that Dan Jones and Shelly Jones are married, are related, etc.) with probability 65%. Identity storage device 210 may make this determination based on, for example, information indicating that Dan Jones and Shelly Jones were on the same flight, information indicating that Shelly Jones bought two tickets for flight number 99, information indicating that Dan Jones and Shelly Jones have the same last name, or the like.

As indicated above, FIGS. 5A-5D are provided as an example. Other examples are possible and may differ from what was described with regard to FIGS. 5A-5D.

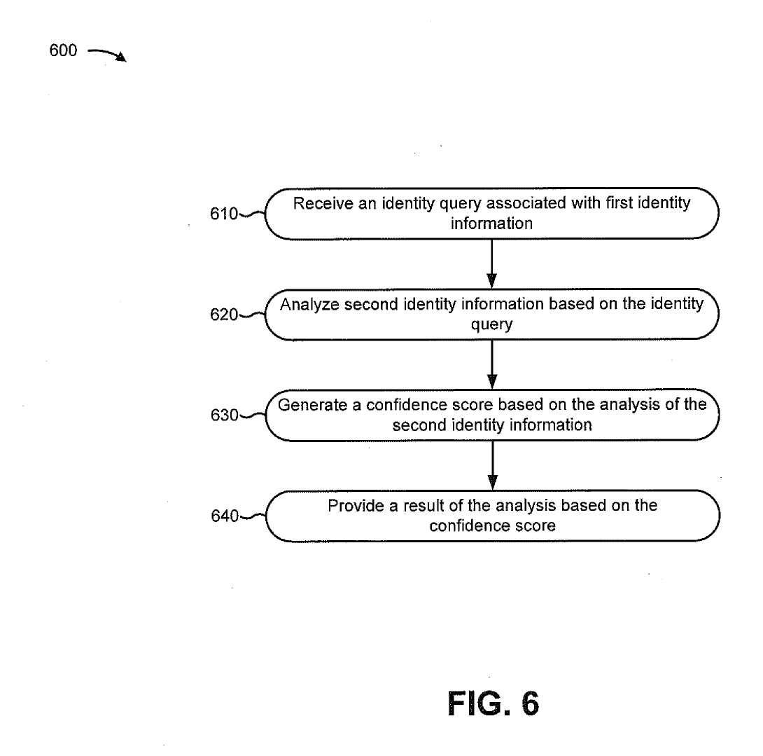

FIG. 6 is a flow chart of an example process 600 for analyzing identity information to generate and provide a result based on an identity query. In some implementations, one or more process blocks of FIG. 6 may be performed by identity storage device 210. In some implementations, one or more process blocks of FIG. 6 may be performed by another device or a group of devices separate from or including identity storage device 210, such as source device 220 and/or client device 230.

As shown in FIG. 6, process 600 may include receiving an identity query associated with first identity information (block 610), and analyzing second identity information based on the identity query (block 620). For example, identity storage device 210 may receive an identity query from client device 230. The identity query may identify first identity information (e.g., a person, an attribute, or the like). In some implementations, the first identity information may include a type of identity information and/or a value of identity information. Identity storage device 210 may analyze second identity information, such as information stored by identity storage device 210, to determine second identity information that matches the type and/or the value of the first identity information specified in the identity query.

As an example, a user may input, via client device 230, an identity query that specifies one or more attributes, such as a date of birth and a citizenship. Identity storage device 210 may receive the identity query from client device 230, and may analyze stored identity information to determine a list of people with the specified date of birth and citizenship (e.g., a list of people for which identity storage device 210 stores a relationship between the people and the attributes).

In some implementations, the identity query may specify a relationship associated with one or more items of identity information, and identity storage device 210 may analyze stored identity information to determine information that matches and/or is similar to the relationship and the one or more items of identity information. For example, a user may input, via client device 230, an identity query that specifies a particular person and a relationship of “knowing” the person. Identity storage device 210 may receive the identity query from client device 230, and may analyze stored identity information to determine a list of people that know the particular person (e.g., a list of people for which identity storage device 210 stores a “knows” relationship between the people and the particular person).

The identity query may specify a time element in some implementations, and identity storage device 210 may analyze stored identity information based on the time element. Additionally, or alternatively, a user may input, via client device 230, an identity query that specifies one or more attributes and/or relationships, and a particular time and/or period of time associated with the attributes and/or relationships. For example, the user may input, via client device 230, an identity query that specifies an attribute of “voted Republican” and a time element of “between 1984 and 1988.” Identity storage device 210 may receive the identity query from client device 230, and may analyze stored identity information to determine a list of people that voted Republican between 1984 and 1988.

In some implementations, the identity query may specify a confidence score, and identity storage device 210 may analyze stored identity information based on the confidence score. As discussed in more detail below, identity storage device 210 may generate a confidence score for a result of an analysis performed based on the identity query. The confidence score may indicate a likelihood of a match between first identity information specified in an identity query and second identity information stored by identity storage device 210 (e.g., a likelihood that a person has a specified attribute, a likelihood that a person knows another person, a credibility score associated with a relationship, etc.). Identity storage device 210 may determine stored identity information that matches and/or has a relationship with requested identity information with a confidence score that satisfies a threshold identified in the identity query (e.g., the specified confidence score).

In some implementations, the identity query may include a request to verify an identity. For example, a user may input, via client device 230, first identity information, associated with a person whose identity is to be verified, such as a name and passport number of the person. Identity storage device 210 may receive the identity query from client device 230, and may analyze stored identity information to determine a likelihood that the person is who they say they are (e.g., a confidence score for a relationship between the name and the passport number).

Additionally, or alternatively, the identity query may include a request to predict a behavior of a person. For example, a user may input, via client device 230, first identity information, associated with a person whose behavior is to be predicted, and information identifying the behavior to be predicted. Identity storage device 210 may receive the identity query from client device 230, and may analyze stored identity information to determine a likelihood that the person will exhibit the behavior (e.g., a confidence score indicating a likelihood that the person will perform a particular action). In some implementations, the prediction may be associated with a time element (e.g., whether the person is likely to perform the behavior within a particular time period).

In some implementations, the identity query may include information associated with a temporary scenario. For example, a user may provide identity information, information that identifies a relationship between items of identity information, and/or information that identifies a credibility score (e.g., for a relationship). The user may indicate that the provided information is associated with a temporary scenario. Identity storage device 210 may process the identity query based on the provided information associated with the temporary scenario.

As further shown in FIG. 6, process 600 may include generating a confidence score based on the analysis of the second identity information (block 630). For example, identity storage device 210 may generate a confidence score based on an identity query received from client device 230, and further based on second identity information stored by identity storage device 210.

In some implementations, the confidence score may indicate a likelihood of a match between first identity information specified in an identity query and second identity information stored by identity storage device 210 (e.g., a likelihood that a person has a specified attribute, a likelihood that a person knows another person, a credibility score associated with a relationship, etc.). The confidence score may include and/or may be based on one or more credibility scores (e.g., a likelihood that a stored relationship is an accurate representation of an actual relationship between items of identity information).

Additionally, or alternatively, the confidence score may indicate a confidence level for an identity verification. For example, the confidence score may indicate a likelihood that a person claiming to have a particular identity (e.g., based on a credential and/or an attribute) actually has the particular identity. For example, identity storage device 210 may receive identity information associated with a person having a particular fingerprint. The confidence score may indicate that the person, claiming to have a particular identity, has a 95% chance of having the particular identity based on the particular fingerprint matching stored fingerprint information associated with the person. In some implementations, the confidence score may indicate a likelihood that the received identity information distinguishes the person from other people identified by identity storage device 210 (e.g., other identities stored by identity storage device 210).

Additionally, or alternatively, the confidence score may indicate a confidence level for a behavior prediction. For example, the confidence score may indicate a likelihood that a person will exhibit a particular behavior (e.g., will perform a particular action). For example, the confidence score may indicate a likelihood that a person will visit a particular country within the next year.

In some implementations, identity storage device 210 may generate the confidence score based on a normal distribution. For example, identity storage device 210 may determine a first normal distribution that indicates a likelihood that a relationship is accurate (e.g., a likelihood that an identity is true and a person is who the person is claiming to be), and/or may determine a second normal distribution that indicates a likelihood that a relationship is not accurate (e.g., a likelihood that an identity is false and a person is not who the person is claiming to be). Identity storage device 210 may generate the confidence score based on the first normal distribution and/or the second normal distribution. In some implementations, identity storage device 210 may generate the confidence score using a probabilistic model other than a normal distribution. Identity storage device 210 may update the probabilistic model (e.g., the normal distribution) as additional identity information is received. In this way, a confidence score generated by identity storage device 210 may become more accurate over time.

In some implementations, identity storage device 210 may receive user input that specifies a confidence score. Additionally, or alternatively, a user may indicate that a particular confidence score is associated with a temporary scenario. For example, a user may a confidence score for a temporary scenario, and identity storage device 210 may store the confidence score along with an indication that the confidence score is associated with a temporary scenario. Identity storage device 210 may process an identity query based on the stored confidence score. In some implementations, the user may provide input indicating that identity storage device 210 is to delete a confidence score associated with the temporary scenario, and identity storage device 210 may remove information that identifies the confidence score from storage based on receiving the indication.

As further shown in FIG. 6, process 600 may include providing a result of the analysis based on the confidence score (block 640). For example, identity storage device 210 may provide, to client device 230, a result of the analysis. The result may identify, for example, one or more items of identity information (e.g., one or more people) that have a relationship with another one or more items of identity information (e.g., one or more attributes) specified in the identity query. In some implementations, the result may be provided based on the relationship having a particular likelihood, based on a generated confidence score (e.g., a confidence score, for the relationship, that satisfies a threshold).

In some implementations, the result may identify the confidence score. Additionally, or alternatively, the result may provide an indication (e.g., based on the confidence score) of a likelihood that a person claiming to have a particular identity (e.g., based on a credential and/or an attribute) actually has the particular identity. In some implementations, the result may identify a question to ask a person claiming to have a particular identity in order for a user to verify the identity of the person. The result may also identify a correct answer to the question, to be used for verification purposes. The question and the correct answer may be based on stored identity information.

In some implementations, the result may be associated with a temporary scenario. For example, identity storage device 210 may receive (e.g., based on user input) information associated with a temporary scenario (e.g., temporary identity information, a temporary relationship, a temporary credibility score, a temporary confidence score, etc.). Identity storage device 210 may analyze stored identity information based on the information associated with the temporary scenario, and may provide a result of the analysis. In some implementations, identity storage device 210 may provide an indication that the result is based on information associated with a temporary scenario.

While a series of blocks has been described with regard to FIG. 6, the blocks and/or the order of the blocks may be modified in some implementations. Additionally, or alternatively, non-dependent blocks may be performed in parallel. Furthermore, one or more blocks may be omitted in some implementations.

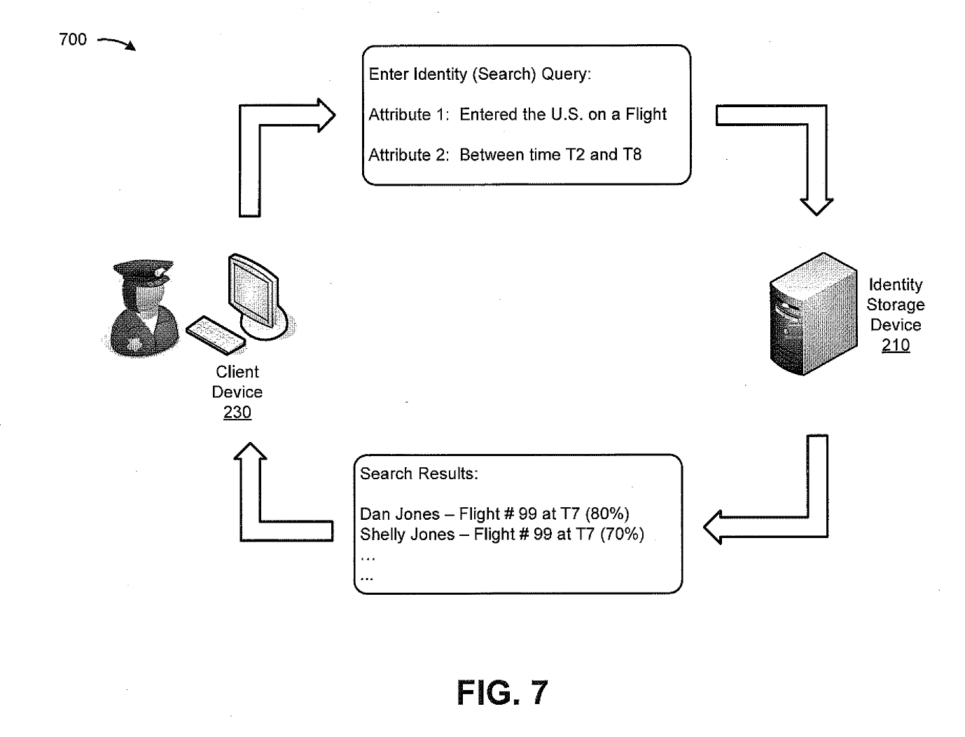

FIG. 7 is a diagram of an example implementation 700 relating to example process 600 shown in FIG. 6. FIG. 7 shows an example where identity storage device 210 receives an identity query that includes search criteria for identity information, analyzes identity information stored by identity storage device 210 to determine identity information associated with the search criteria, and provides a result of the analysis to client device 230.

As shown in FIG. 7, assume that a user, interacting with client device 230, inputs two attributes as search criteria for an identity query. The attributes are “entered the U.S. on a flight” and “between time T2 and T8.” Client device 230 may transmit the identity query to identity storage device 210, as shown. Identity storage device 210 may analyze stored identity information to determine one or more people that entered the U.S. on a flight between time T2 and T8. For example, identity storage device 210 may determine people that have a relationship with a first attribute of “entered the U.S. on a flight,” and where the first attribute has a relationship with a second attribute of “between time T2 and T8.”

Identity storage device 210 may determine a confidence score for the relationship between a person and the two attributes. The confidence score may be based on the relationship between the person and one or more of the attributes, a relationship between the attributes, or the like. For example, identity storage device 210 may determine, with a confidence score of 80%, that a person named Dan Jones was on a flight that entered the U.S. between time T2 and T8, as shown. As further shown, identity storage device 210 may determine, with a confidence score of 70%, that a person named Shelly Jones was on a flight that entered the U.S. between time T2 and T8. Identity storage device 210 may provide the determined information and the confidence score to client device 230, as shown. As further shown, identity storage device 210 may provide additional information to client device 230, such as a flight number (e.g., Flight #99) and a time at which the flight arrived (e.g., T7).

As indicated above, FIG. 7 is provided as an example. Other examples are possible and may differ from what was described with regard to FIG. 7.

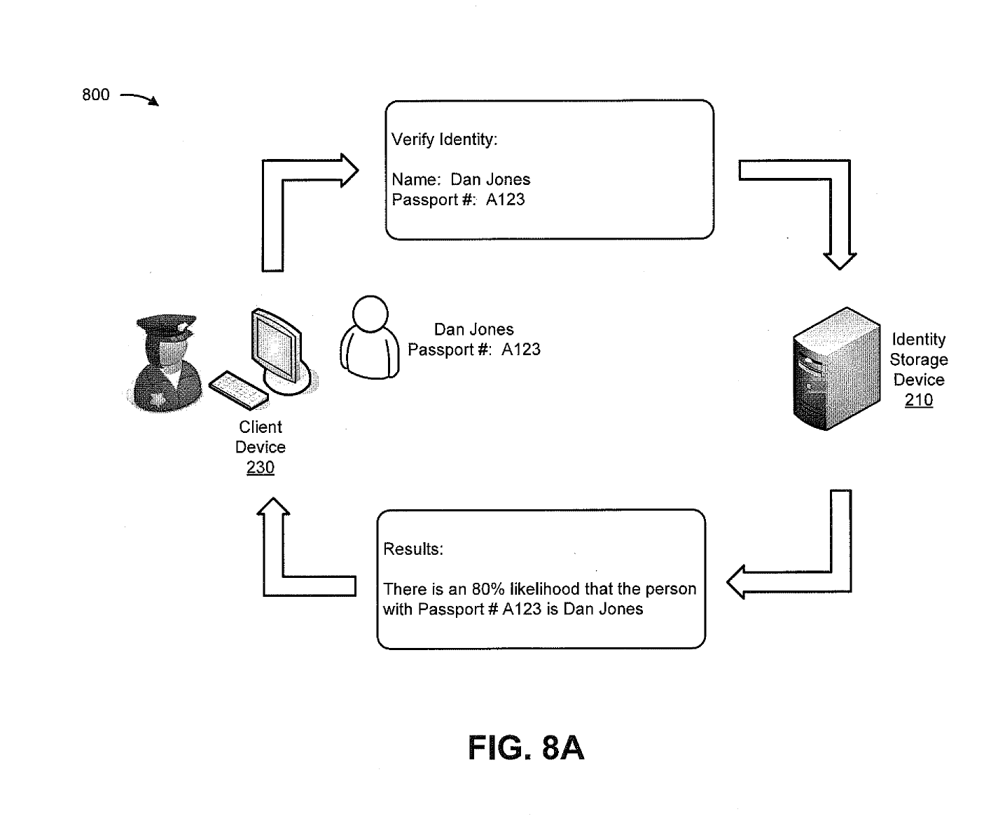

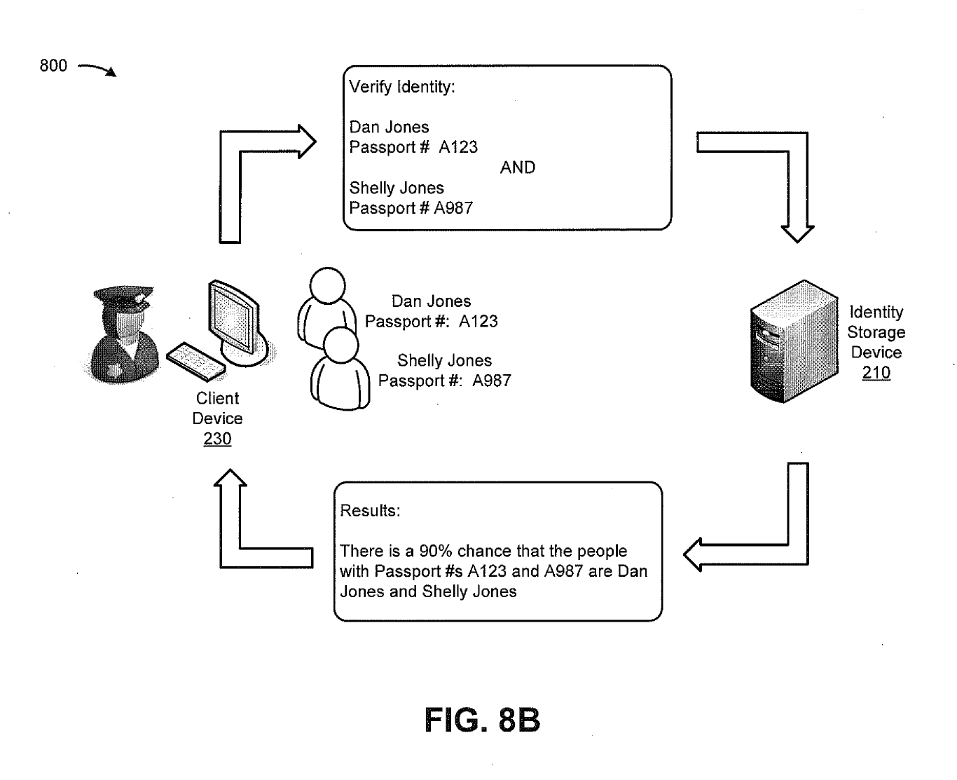

FIGS. 8A and 8B are diagrams of another example implementation 800 relating to example process 600 shown in FIG. 6. FIGS. 8A and 8B show an example where identity storage device 210 receives an identity query that includes a request to verify an identity, analyzes identity information stored by identity storage device 210 to determine a confidence score for the identity verification, and provides a result of the analysis to client device 230.

As shown in FIG. 8A, assume that a user, such as a customs official, wishes to verify an identity of a person entering a country. The person entering the country provides the customs official with a document that identifies the person as Dan Jones with a passport number of A123. Further assume that the user, interacting with client device 230, inputs identity information for verification. The identity information includes a name of “Dan Jones” and a passport number of “A123.”

Client device 230 may transmit the identity information to identity storage device 210, as shown. Identity storage device 210 may analyze stored identity information to determine a confidence score for the identity verification. For example, identity storage device 210 may determine a credibility score for a relationship between a person named Dan Jones and a passport number of A123, and may generate the confidence score based on the credibility score (e.g., the confidence score may be equal to the credibility score and/or may be calculated based on the credibility score). Identity storage device 210 may determine that there is an 80% likelihood that the person that gave the customs official the document is actually Dan Jones. Identity storage device 210 may provide the determined information and the confidence score to client device 230, as shown. In this way, the user may verify the identity of the person.

As shown in FIG. 8B, assume that a user, such as a customs official, wishes to verify an identity of two people entering a country together. The two people entering the country provide the customs official with documents that identify the first person as Dan Jones with a passport number of A123, and that identify the second person as Shelly Jones with a passport number of A987. Further assume that the user, interacting with client device 230, inputs identity information for verification. The identity information includes a name of “Dan Jones” and a passport number of “A123” for the first person, and a name of “Shelly Jones” and a passport number of “A987” for the second person.

Client device 230 may transmit the identity information to identity storage device 210, as shown. Identity storage device 210 may analyze stored identity information to determine a confidence score for the identity verification. For example, identity storage device 210 may determine one or more credibility scores for a relationship between a person named Dan Jones and a passport number of A123, a relationship between a person named Shelly Jones and a passport number of A987, and/or a relationship between Dan Jones and Shelly Jones, and may generate a confidence score based on the one or more credibility scores. Identity storage device 210 may determine that there is a 90% likelihood that the people that gave the customs official the documents are actually Dan Jones and Shelly Jones. Assume that the confidence score for verifying an identity of Dan Jones and Shelly Jones together is higher than a confidence score for verifying an identity of Dan Jones alone because identity storage device 210 stores a relationship between Dan Jones and Shelly Jones. Identity storage device 210 may provide the determined information and the confidence score to client device 230, as shown. In this way, the user may verify the identity of the people.

As indicated above, FIGS. 8A and 8B are provided as an example. Other examples are possible and may differ from what was described with regard to FIGS. 8A and 8B.

Implementations described herein may provide a more accurate representation of a person's identity by taking into account changes in the person's attributes over time, as well as by determining probabilistic relationships between the person, other people, and/or attributes of the person. Additionally, implementations described herein may assist a user in determining people with particular attributes, and in verifying an identity of a person.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

One or more steps of a method claim listed below may be performed by a device, an apparatus, a processor, etc. Furthermore, a computer-readable medium may store instructions that, when executed by a processor, cause the processor to perform one or more steps of a method claim listed below.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A system, comprising:
one or more devices to:
receive identity information associated with a person;
determine a relationship between at least one of:
the person and another person; or
the person and an attribute;
generate a credibility score, associated with the relationship, that indicates a likelihood that the relationship is an accurate representation of the person;
receive an identity query associated with the identity information;
generate a confidence score based on the identity information, the credibility score, and the identity query; and
provide, based on receiving the identity query, a result based on the confidence score.

2. The system of claim 1, where the credibility score is based on at least one of:
a source of the identity information;
a value of the identity information; or
a quantity of times that the identity information is received.

3. The system of claim 1, where the one or more devices are further to:
receive additional identity information associated with the person; and
modify the credibility score based on the additional identity information.

4. The system of claim 3, where the additional identity information identifies an adjudicatory decision made by a user; and
where the one or more devices, when modifying the credibility score, are further to:
modify the credibility score based on the adjudicatory decision.

5. The system of claim 4, where the one or more devices are further to:
receive information that conflicts with the adjudicatory decision;
override the adjudicatory decision based on receiving the information that conflicts with the adjudicatory decision; and
modify the credibility score based on overriding the adjudicatory decision.

6. The system of claim 1, where the one or more devices are further to:
determine a similarity between the identity information and stored identity information associated with the person; and
where the one or more devices, when generating the credibility score, are further to:
generate the credibility score based on the determined similarity.

7. The system of claim 1, where the result based on the confidence score indicates at least one of:
a likelihood of a match between an item of the identity information and an item of stored identity information;
a likelihood that the person will exhibit a particular behavior; or
a likelihood that the person, claiming to have a particular identity, has the particular identity.

8. A computer-readable medium storing instructions, the instructions comprising:
one or more instructions that, when executed by one or more processors, cause the one or more processors to:
receive identity information associated with an identity;
determine a relationship between at least one of:
the identity and another identity; or
the identity and an attribute;
determine a credibility score, associated with the relationship, that indicates a likelihood that the relationship is an accurate representation of the identity;
determine a confidence score based on the identity information and the credibility score; and
output or store the confidence score.

9. The computer-readable medium of claim 8, where the credibility score is based on at least one of:
a source of the identity information;
a value of the identity information; or
a quantity of times that the identity information is received.

10. The computer-readable medium of claim 8, where the one or more instructions, when executed by the one or more processors, further cause the one or more processors to:
receive additional identity information associated with the identity; and
modify the credibility score based on the additional identity information.

11. The computer-readable medium of claim 10, where the additional identity information identifies an adjudicatory decision made by a user; and
where the one or more instructions, that cause the one or more processors to modify the credibility score, further cause the one or more processors to:
modify the credibility score based on the adjudicatory decision.

12. The computer-readable medium of claim 8, where the one or more instructions, when executed by the one or more processors, further cause the one or more processors to:
receive an identity query associated with the identity information;
where the one or more instructions, that cause the one or more processors to determine the confidence score, further cause the one or more processors to:
determine the confidence score based on the identity query; and
where the one or more instructions, that cause the one or more processors to output or store the confidence score, further cause the one or more processors to:
provide, based on receiving the identity query, a result based on the confidence score.

13. The computer-readable medium of claim 8, where the one or more instructions, when executed by the one or more processors, further cause the one or more processors to:
determine a similarity between the identity information and stored identity information associated with the identity; and
where the one or more instructions, that cause the one or more processors to determine the credibility score, further cause the one or more processors to:
determine the credibility score based on the determined similarity.

14. The computer-readable medium of claim 8, where the confidence score indicates at least one of:
a likelihood of a match between an item of the identity information and an item of other identity information,
the other identity information being different from the identity information;
a likelihood that a person, associated with the identity, will perform a particular action; or
a likelihood that the person, claiming to have a particular identity, has the particular identity.

15. A method, comprising:
receiving, by a device, identity information associated with a person;
determining, by the device, a relationship between at least one of:
the person and another person; or
the person and an attribute;
determining, by the device, a credibility score associated with the relationship,
the credibility score indicating a likelihood that the relationship is an accurate representation of the person;
determining, by the device, a confidence score based on the identity information and the credibility score; and
outputting or storing, by the device, the confidence score.

16. The method of claim 15, where the credibility score is based on at least one of:
a source of the identity information;
a value of the identity information; or
a quantity of times that the identity information is received.

17. The method of claim 15, further comprising:
receiving additional identity information associated with the person; and
modifying the credibility score based on the additional identity information.

18. The method of claim 15, further comprising:
receiving an identity query that includes other identity information;
where determining the confidence score further comprises:
determining the confidence score based on the other identity information; and
where outputting or storing the confidence score further comprises:
providing, based on receiving the identity query, a result based on the confidence score.

19. The method of claim 15, further comprising:
determining a similarity between the identity information and stored identity information associated with the person; and
where determining the credibility score further comprises:
determining the credibility score based on the determined similarity.

20. The method of claim 15, where the confidence score indicates at least one of:
a likelihood of a match between an item of the identity information and an item of other identity information;
a likelihood that the person will exhibit a particular behavior; or
a likelihood that the person, claiming to have a particular identity, has the particular identity.
